(19) United States
(12) Patent Application Publication
(10) Pub. No.: US 2003/0223735 A1
(43) Pub. Date: Dec. 4, 2003

(54) System and a method for receiving and storing a transport stream for deferred presentation of a program to a user

(76) Inventor: William B. Boyle, Lake Forest, CA (US)

Correspondence Address: WESTERN DIGITAL CORP., 20511 LAKE FOREST DRIVE, C205 - INTELLECTUAL PROPERTY DEPARTMENT, LAKE FOREST, CA, 92630, US

(21) Appl. No.: 09/796,835

(22) Filed: Feb. 28, 2001

(51) Int. Cl. H04N 5/76; H04N 5/781

(52) U.S. Cl. 386/111; 386/125

(57) ABSTRACT

An audio/video apparatus has an input port to receive a transport stream from a source of programs. The transport stream includes program data that is encoded and that represents at least one program to be presented to a user. A storage device is coupled to the input port and is configured to record the transport stream. A decoder is configured to be coupled to the storage device to obtain the encoded program data of the transport stream from the storage device and to decode the encoded program data. A control device is coupled to the storage device and the decoder, wherein the control device controls a variable rate with which the decoder receives the program data from the storage device.

### BACKGROUND OF THE INVENTION

1. Field of the Invention

The invention relates to a system for presenting a program to a user. More particularly, the invention relates to a method, system and apparatus for receiving and storing a program for presentation to a user.

2. Description of the Related Art

A conventional system for displaying a program, e.g., a video program, includes a monitor or a television (TV) set connected to a set top box. The set top box is connected through a coaxial cable to a cable TV network or a satellite dish for “satellite TV.” The TV set and the set top box are located, for example, in a user's home and receive a multitude of TV channels from a broadcast head end, wherein each TV channel has a multitude of programs during a typical day. In order to select and watch a certain program, the user controls, for example, the set top box to tune to a desired channel. The TV set receives a video signal from the set top box and displays the program of the desired channel.

A user may expand the system by connecting a video recorder to the TV set and the set top box to personalize television viewing by recording a program and watching it when it is convenient for the user. Further, the user may subscribe to and receive premium content such as subscription channels, pay-per-view services or video-on-demand services in order to watch a movie on a certain day and at a time of day for which the user has to pay a per-movie fee. The user may further personalize television viewing by subscribing to services such as ReplayTV (offered by Replay Network) and TiVo (offered by Philips). For instance, the video recorder may be a digital video recorder that includes a hard disk drive with a storage capacity of between 10 GB and 30 GB for recording of up to 30 hours of television programming.

In order to accommodate personalized television, the systems transmit, process and store large quantities of program data. For instance, in a conventional system, an encoder is used to compress and to encode the program data, and a decoder is used to decompress and to decode the program data. The encoder outputs a stream of program data that has a reduced bit rate and a reduced redundancy. The encoder and decoder usually operate in accordance with international standards, e.g., a compression process defined by the Moving Picture Expert Group (MPEG), e.g., MPEG-2, or by the International Telecommunications Union (ITU), e.g., the H.263 standard, that define uniform requirements for coding and decoding of program data.

For instance, the MPEG-2 compression of a program by an MPEG-2 decoder at the broadcast head end results in a single compressed program, which is referred to as “single-program elementary stream.” The MPEG-2 decoder packetizes a single-program elementary stream to generate a packetized elementary stream (PES). An MPEG-2 program multiplexer multiplexes a group of packetized elementary streams into a “transport stream.” The transport stream includes multiple series of fixed-size data packets. Each data packet comprises a payload and a header that includes packet identification (“PID”) values. The broadcast head end transmits the transport stream at a constant data rate.

The different series of data packets of the transport stream are generally generated by different MPEG encoders, which typically have different compression factors and different system time clocks (STCs). The different system time clocks generally are not synchronized to one another. In changing from one program to the next, an MPEG decoder synchronizes its STC with the STC, which was used during the encoding of each program. This synchronization avoids jitter in the decoded data stream, and avoids “overflow” or “underflow” of a memory buffer of the MPEG decoder. To provide the synchronization data needed to decode the series of data packets, the data packets are encoded with program clock reference (PCR) information.

During the encoding of audio/video data, a fixed-frequency STC (e.g., 27 MHz) of an MPEG encoder drives a constantly running binary counter. The value of the counter is sampled periodically and placed in the data packet headers as PCR information. At the decoder, the PCR value of the data packet is compared with the local PCR value, which is driven by a STC with nominally the same frequency (i.e., 27 MHz). The difference in these PCR values (the PCR phase error) thereby allows the MPEG decoder to properly synchronized its STC to the STC of the MPEG encoder for a selected series of data packets, thereby duplicating the same frame rate used at the MPEG encoder with the frame rate generated at the MPEG decoder. Note that because the timing of the presentation of these PCR values at the MPEG decoder is critical for the MPEG decoder to operate correctly, the PCR method relies on the MPEG decoder receiving the series of data packets for a particular program with the same interpacket time intervals as the series of data packets had when they were transmitted from the MPEG encoder.

The PCR method is optimized for presenting a program to a user as a “live”program. That is, an audio/video receiver processes the transport stream as it is received, and the decoder decodes the selected program for instant presentation to the user. However, when the user uses a PVR to record a program for deferred presentation, timing information is particularly critical for the decoder in order to properly play back the program. Therefore, there is a need for an improved technique for presenting a program to a user.

### SUMMARY OF THE INVENTION

The present invention may be regarded as an audio/video apparatus having an input port to receive a transport stream from a source of programs. The transport stream includes program data that is encoded and that represents at least one program to be presented to a user. A storage device is coupled to the input port and is configured to record the transport stream. A decoder is configured to be coupled to the storage device to obtain the encoded program data of the transport stream from the storage device and to decode the encoded program data. A control device is coupled to the storage device and the decoder, wherein the control device controls a variable rate with which the decoder receives the program data from the storage device.

The present invention may also be regarded as a method of receiving and storing program data. The method receives at an input port of an audio/video apparatus a transport stream from a source of program data. The transport stream includes program data that is encoded and that represents at least one program to be presented to a user. the method records the transport stream on a storage device. The method obtains the transport stream from the storage device and decodes the encoded program data of the transport stream using a decoder. The method controls a variable rate with which the transport stream is obtained from the storage device.

The present invention may further be regarded as a method of operating an audio/video apparatus. The method records a transport stream that includes encoded program data representing at least one program to be presented to a user. The method plays back the transport stream to input encoded program data into a decoder with which a buffer memory is associated. Further, the method controls a variable rate with which the transport stream is played back to maintain program data in the buffer memory between an upper fill level and a lower fill level.

The present invention may additionally be regarded as an audio/video system having a storage device coupled to record a transport stream that includes encoded program data representing at least one program to be presented to a user. A decoder is coupled to the storage device to receive the encoded program data of the transport stream from the storage device during a playback mode and to decode the encoded program data. The decoder is associated with a buffer memory. A controller is coupled to the storage device and to the decoder. The controller is configured to adjust a variable rate with which the decoder receives the encoded program data from the storage device so that program data in the buffer memory is maintained between an upper fill level and a lower fill level.

### BRIEF DESCRIPTION OF THE DRAWINGS

These and other aspects, advantages, and novel features of the invention will become apparent upon reading the following detailed description and upon reference to the accompanying drawings. In the drawings, same elements have the same reference numerals.

FIG. 1 shows an embodiment of a system in accordance with an embodiment of the present invention that includes a head end coupled to an audio/video apparatus, wherein the head end transmits a transport stream including program data representing at least one program, wherein a storage device of the audio/video apparatus records the transport stream before a decoder decodes the encoded program data, and wherein a control device controls a variable rate with which the decoder receives the program data from the storage device.

FIG. 2 shows an embodiment of the system in accordance with the present invention that includes a control device that provides for a first path for program data and a second path for a control signal, wherein the second path includes a controller and forms a feedback loop between the decoder and the storage device.

FIG. 3 is a flowchart of a procedure illustrating the method in accordance with an embodiment of the present invention that receives and records a transport stream on a storage device and controls a variable rate with which a decoder receives program data from the storage device.

### DETAILED DESCRIPTION OF THE PREFERRED EMBODIMENT

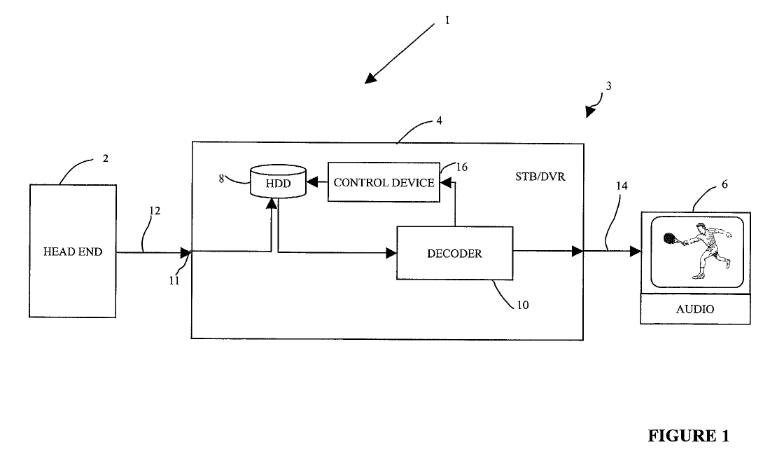

FIG. 1 illustrates an embodiment of a system 1 for transmitting and receiving a program in accordance with an embodiment of the present invention, which is configured to operate in accordance with the method of the present invention. The system 1 includes a head end 2 and an audio/video (“A/V”) apparatus 3 coupled to the head end 2 via a network 12. The A/V apparatus 3 includes an A/V receiver 4 and an audio/display device 6 coupled to the A/V receiver 4 via a connection 14. The head end 2 includes a source for a program (e.g., a video program, an audio program, text, images, or data content) and a transmitter to generate and to send a transport stream to the A/V apparatus 3 as known in the art.

The A/V receiver 4 includes a storage device 8 (HDD) coupled to an input port 11 of the A/V receiver 4, a decoder 10 and a control device 16. The input port 11 is configured to receive the transport stream from the source of programs, wherein the transport stream includes program data that is encoded and that represents at least one program to be presented to a user. In one embodiment, the transport stream conforms to the MPEG standard and includes packetized elementary streams. The storage device 8 is configured to record the transport stream received at the input port 11. Further, the storage device 8 may store various types of system information.

In one embodiment, the storage device 8 comprises a hard disk drive (HDD) compatible with a version of the ATA (AT-attachment) specification, such as IDE (Integrated Drive Electronics). The ATA specification describes power interfaces and data signal interfaces between the central processor device (e.g., a motherboard of a PC) and an integrated disk controller and the hard disk drive. In another embodiment, the storage device 8 comprises a hard disk drive compatible with the SCSI (Small Computer System Interface) specification. In yet another embodiment, the storage device 8 comprises a hard disk drive compatible with the IEEE 1394 standard, which is described in “IEEE Std. 1394-1995 IEEE Standard for High Performance Serial Bus,” Aug. 30, 1996, which is incorporated by reference herein. Further, the storage device 8 compatible with the present invention may utilize any technology that provides writable non-volatile storage (e.g., a writable digital video disk (DVD) drive).

The decoder 10 is coupled to the storage device 8 and is configured to obtain the encoded program data of the transport stream from the storage device 8 and to decode the encoded program data. The control device 16 is coupled to the storage device 8 and to the decoder 10 and is configured to control a variable rate with which the decoder 10 receives the program data from the storage device 8.

In accordance with the present invention, the storage device 8 records the transport stream. At a later time and upon a user selecting a program for presentation, the storage device 8 plays back the transport stream into the decoder 10. Further, in accordance with the present invention, the control device 16 is part of a feedback loop that includes the storage device 8 and the decoder 10. During playback, the control device 16 monitors the decoder 10 and adjusts the variable rate so that the decoder 10 receives the program data at an optimized rate without causing a memory associated with the decoder 10 to overflow or underflow as described below. It is contemplated that the feedback loop is inactive when the user watches a “live” program.

In one embodiment, the A/V receiver 4 may be implemented within a set top box (STB), a digital (personal) video recorder (DVR), or a combination of a set top box and a digital video recorder. Those skilled in the art will appreciate that a DVR may perform a variety of functions including pre-programmed functions and user-defined and user-initiated functions. An exemplary DVR is described in copending U.S. patent application No. 09/585,249, filed May 31, 2000, entitled “Digital Video Recorder Connectable To An Auxiliary Interface Of A Set-Top Box That Provides Video Data Stream To A Display Device Based On Selection Between Recorded Video Signal Received From The Digital Video Recorder And A Real-Time Video Signal,” which is incorporated by reference herein.

The audio/display 6 is configured to present multimedia content to the user. The audio/video device 6 may be a TV, a computer monitor or any other display for displaying video and TV programs, text, images, or combinations thereof. Further, the audio/video device 6 may include an audio system for presenting audio programs to the user.

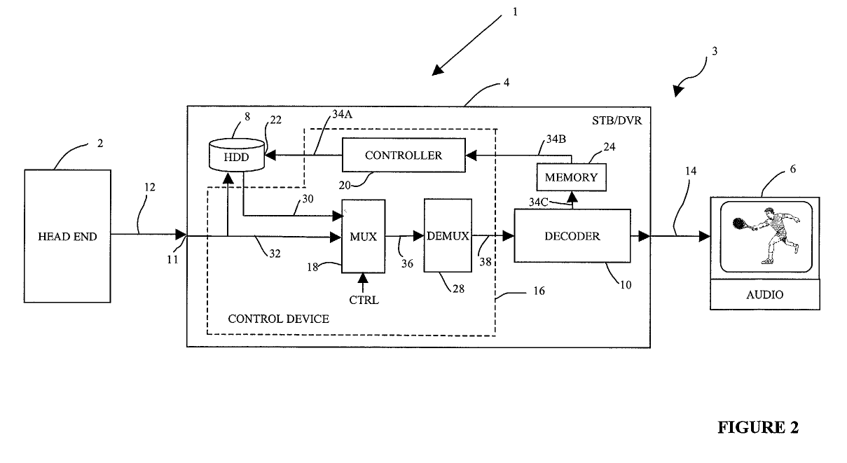

FIG. 2 shows the system 1 with an embodiment of the A/V receiver 4 in which the control device 16 provides for a first path (18, 28, 30, 32, 36, 38) for program data and a second path (20, 24, 34A, 34B, 34C) for a control signal. In the illustrated embodiment, the first path includes a multiplexer (MUX) 18 and a demultiplexer (DEMUX) 28. The demultiplexer 28 is coupled via a data line 36 to an output of the multiplexer 18 and via a data line 38 to an input of the decoder 10. The multiplexer 18 has a first input connected to a data line 30, which is connected to an output of the storage device 8. A second input of the multiplexer 18 is connected to a data line 32, which is connected to the input port 11 and an input of the storage device 8.

The second path includes a memory 24 and a controller 20. The controller 20 is connected via a control line 34A to a control input 22 of the storage device 8, and via a control line 34B to the memory 24. The memory 24 is coupled via a data line 34C to the decoder 10. It is contemplated that the memory 24 may be a first in, first out buffer (FIFO) or a random access memory, such as the SRAM, DRAM or FLASH RAM. Further, it is contemplated that the memory 24 may be part of the decoder 10.

The multiplexer 18 has a control input (CTRL) to receive a control signal from a system CPU. Depending on the control signal, the multiplexer 18 connects either the first input port or the second input to the output of the multiplexer 18. That is, if the user selected a “live” program the control signal selects the second input on the data line 32, and the transport stream received at the input port 11 is forwarded to the demultiplexer 28. However, if the user selects a recorded program, the control signal selects the first input of the multiplexer 18 on the data line 30, and the recorded transport stream is forwarded to the demultiplexer 28.

The demultiplexer 28 performs the reverse operation of a transport stream (program) multiplexer (not shown) that originally generated to the transport stream. In one embodiment, the transport stream multiplexer is included in the head end 2. That is, the demultiplexer 28 demultiplexes the program streams of the received transport stream and forwards only the program stream that represents the selected program to the decoder 10. The selected program stream is then available for further decoding.

The decoder 10 decodes and reconstructs the selected program in accordance with the decoding procedure defined by the MPEG-2 standard using, among others, the PID values and the tables PAT and PMT. The audio/video device 6 presents then the selected program to the user.

The memory 24 temporarily buffers program data of the transport stream during the process of decoding the program data. The decoder 10 processes the program data at a rate determined by a local clock. Ideally, the decoder clock is synchronous with the encoder clock according to which the transport stream has been generated. During a “live” program, the decoder 10 therefore processes the program data essentially with the same rate as the program data is received. However, if the decoder clock and the encoder clock deviate, the decoder 10 receives the program data too fast if the decoder clock is slower than the encoder clock or receives the program data too slow if the decoder clock is faster than the encoder clock.

The memory 24 also temporarily buffers program data during playing back of a recorded program. Data streaming rates for continuously streaming program data (e.g., 1 Mb/s) are typically much lower than the instantaneous data transfer rates for transferring data packets from storage devices that comprise hard disk drives (e.g., 66 Mb/s). The memory 24 thus serves as a temporary repository of program data in order to maintain a rate that is adapted to the decoder rate.

In one embodiment, the memory 24 has an upper fill level and a lower fill level, wherein the memory 24 “overflows” when a current fill level exceeds the upper fill level, and wherein the memory 24 “underflows” when a current fill level falls below the lower fill level. In one embodiment, the memory 24 advantageously has a buffer capacity of 2 Mbytes.

The controller 20 in accordance with the present invention monitors the fill level of the memory 24 and controls the storage device 8 to maintain the fill level of the memory 24 between the upper fill level and the lower fill level. For example, the fill level may be determined by calculating a difference between a write pointer and a read pointer. In another embodiment, the fill level may be determined by a software algorithm implemented in the decoder or a processor associated with the decoder. Depending on the current fill level of the memory 24, the controller 20 controls a variable rate with which the program data is read from the storage device 8 and therefore controls the rate at which the decoder 10 receives the program data. For example, if the current fill level approaches the upper fill level, the controller 20 reduces the rate so that the decoder 10 receives the program data at a lower rate.

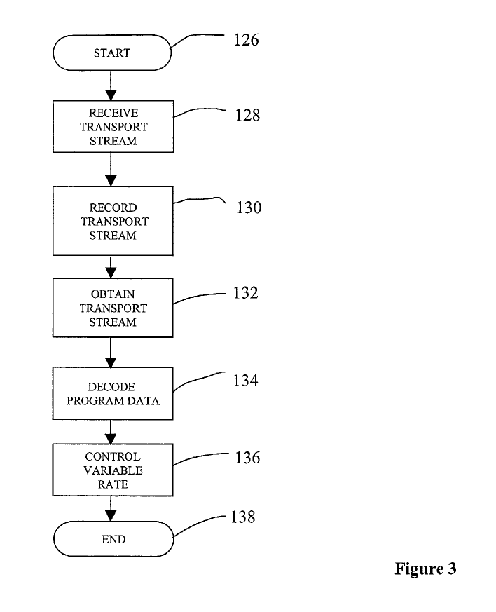

FIG. 3 is a flowchart of a procedure illustrating the method in accordance with the present invention that receives and stores program data at a user location. In one embodiment, the procedure utilizes program data that is encoded and compressed in accordance with the MPEG-2 standard. However, it is contemplated that the invention is generally applicable in connection with other MPEG standards (e.g., MPEG-4) and with systems in which the head end 2 sends the program as a digital signal compressed or encoded in accordance with other compression/encoding techniques.

In a step 126, e.g., when the user turns the A/V receiver 4 on to watch a program, the procedure initializes the system 1. The initialization procedure includes, among others, the step of determining the available storage capacity of the storage device 8.

In a step 128, the procedure receives a transport stream at the input port 11 of the A/V apparatus 4. The transport stream includes program data that is encoded and that represents at least one program to be presented to a user. It is contemplated that the user may select the at least one program of the transport stream for presentation as a “live” program or for deferred presentation at a later time. The following steps of the procedure define the steps in accordance with the present invention during deferred presentation.

In a step 130, the procedure records the transport stream on the storage device 8.

In a step 132, the procedure obtains the transport stream from the storage device 8. That is, in the step 32, the procedure reads the transport stream from the storage device 8 and forwards the transport stream via the data line 30 and the appropriately controlled multiplexer 18 to the demultiplexer 28. The demultiplexer 28 selects from the transport stream the program the user selected for presentation.

In a step 134, the procedure decodes the encoded program data representing the selected program. In one embodiment, the procedure decodes the program data in accordance with the MPEG-2 standard.

In a step 136, the procedure controls the variable rate with which the transport stream is obtained from the storage device 8. The procedure monitors the current fill level of the memory 24 and adjusts the variable rate with which the transport stream is read from the storage device 8. The procedure ends in a step 138.

It is contemplated that the A/V receiver 4 may be implemented within a set top box, a digital video recorder or a combination of a set top box and a digital video recorder. For illustrative purposes, however, FIGS. 1 and 2 show the A/V receiver 4 coupled between the network 22 and the audio/display device 6. Those skilled in the art will a appreciate that in an embodiment with a separate set top box, the set top box is usually coupled to the network 22.

Those skilled in the art will appreciate that, although the drawings show the various elements of the system 1 as individual components, the functionalities of at least some of these elements may be implemented within a single element, such as an ASIC. Further, those skilled in the art will appreciate that at least some functionalities may be implemented in hardware, software, firmware or combinations thereof. For example, the mapping of the program streams may be performed through software.

What is claimed is:

1. An audio/video apparatus, comprising:
an input port configured to receive a transport stream from a source of programs, wherein the transport stream includes program data that is encoded and that represents at least one program to be presented to a user;
a storage device coupled to the input port and configured to record the transport stream;
a decoder configured to be coupled to the storage device to obtain the encoded program data of the transport stream from the storage device and to decode the encoded program data; and
a control device coupled to the storage device and the decoder, the control device configured to control a variable rate with which the decoder receives the program data from the storage device.

2. The apparatus of claim 1, wherein the control device provides for a first path for program data from the storage device to the decoder, and a second path for a control signal from the decoder to the storage device.

3. The apparatus of claim 1, further comprising a multiplexer having a first input coupled to the input port and a second input coupled to an output of the storage device, the multiplexer configured to selectively connect one of the first and second inputs to an output of the multiplexer to provide for direct and deferred presentation of a program to the user.

4. The apparatus of claim 3, further comprising a demultiplexer having an input coupled to the output of the multiplexer and having an output coupled to the decoder, the demultiplexer configured to select from the transport stream a selected program for decoding.

5. The apparatus of claim 1, further comprising a memory coupled to the decoder, the memory configured to buffer program data so that the decoder receives a constant flow of program data and the memory having an upper fill level and a lower fill level.

6. The apparatus of claim 5, wherein the control device includes a controller coupled to the memory and to a control input of the storage device to provide a feedback loop, the controller configured to monitor a fill level of the memory and to adjust the variable rate during deferred presentation of a program to the user, wherein the controller maintains the fill level between the upper fill level and the lower fill level.

7. A method of receiving and storing program data, comprising:
receiving at an input port of an audio/video apparatus a transport stream from a source of program data, wherein the transport stream includes program data that is encoded and that represents at least one program to be presented to a user;
recording the transport stream on a storage device;
obtaining the transport stream from the storage device;
decoding the encoded program data of the transport stream using a decoder; and
controlling a variable rate with which the transport stream is obtained from the storage device.

8. The method of claim 7, further comprising feeding program data along a first path from the storage device to the decoder, and feeding a control signal along a second path from the decoder to the storage device.

9. The method of claim 7, further comprising selecting one of the input port and an output of the storage device to selectively provide for direct and deferred presentation of the program to the user.

10. The method of claim 9, further comprising demultiplexing the transport stream to select from the transport stream a selected program for decoding.

11. The method of claim 10, further comprising buffering the selected program in a memory so that the decoder receives constant flow of program data.

12. The method of claim 11, further comprising monitoring a fill level of the memory and controlling the variable rate so that the fill level of the memory is maintained between an upper fill level and a lower fill level.

13. A method of operating an audio/video apparatus, comprising:
recording a transport stream that includes encoded program data representing at least one program to be presented to a user;
playing back the transport stream to input encoded program data into a decoder with which a buffer memory is associated; and
controlling a variable rate with which the transport stream is played back to maintain program data in the buffer memory between an upper fill level and a lower fill level.

14. An audio/video system, comprising:
a storage device coupled to record a transport stream that includes encoded program data representing at least one program to be presented to a user;
a decoder coupled to the storage device to receive the encoded program data of the transport stream from the storage device during a playback mode and to decode the encoded program data, wherein the decoder is associated with a buffer memory; and
a controller coupled to the storage device and the decoder, the controller configured to adjust a variable rate with which the decoder receives the encoded program data from the storage device so that program data in the buffer memory is maintained between an upper fill level and a lower fill level.
